(19) United States
(12) Patent Application Publication
(10) Pub. No.: US 2010/0191717 A1
(43) Pub. Date: Jul. 29, 2010

(54) OPTIMIZATION OF QUERY PROCESSING WITH TOP OPERATIONS

(76) Inventor: Goetz Graefe, Madison, WI (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/361,455

(22) Filed: Jan. 28, 2009

(51) Int. Cl. G06F 17/30

(52) U.S. Cl. 707/713; 707/E17.014

(57) ABSTRACT

A query processing system performs multiple optimizations of a merge sort for “top” operations. An illustrative query processing system comprises a receiver that receives database query inputs with a top request, and a sort logic that sorts the inputs using temporary files to store intermediate sort data and applies top qualifications to sorted output. An optimizing logic that modifies operation of the sort logic and reduces the number of records in the inputs copied into temporary files.

### BACKGROUND

A fundamental aspect of business intelligence and decision support is setting of priorities. Extracting the most useful query answers from a large database or a large intermediate query result can be very expensive in resource usage, possibly including writing of the “top” operation's entire input to temporary storage. Efficient and robust algorithms for “top” queries have immediate usefulness for query processing in research and industry.

The standard algorithm for “top” operations employs an in-memory priority queue (Michael J. Carey, Donald Kossmann: On Saying “Enough Already!” in SQL. SIGMOD 1997:219-230), usually implemented as a binary heap. Assuming an ascending sort order such that the smallest key values form the desired query result, the heap's root element is the largest key to be included in the result. As each input arrives at the “top” operation, the input's key is compared to the key at the heap's root, the larger one of the two keys is discarded from further consideration, and the smaller key is retained in the priority queue. The algorithm is simple and fast but can only be used if the priority queue and all data records in the operation's output fit in the available memory. For example, the algorithm works well when searching for the “top 3” athletes, but may fail for the “top 1,000,000” propective customers among a country's population or for the “top 10,000,000” site visitors of a popular web site.

If the standard algorithm cannot be used, the common alternative sorts the entire input using an external merge sort and applies the “top” qualification to the sort operation's output, an implementation of “top” operations is simple, correct, and robust, but can be very slow.

In reality, the algorithm considered “standard” in relevant research is often not implemented in database software available for production use. Instead, sorting with subsequent “top” operation is often the only existing alternative since effort for development and testing of additional functionality in query optimization, query execution, and memory management is substantial. In addition, a new choice in query optimization can lead to erroneous choices, customer surprises, and support calls.

### SUMMARY

Embodiments of a query processing system perform multiple optimizations of a merge sort for “top” operations. An illustrative query processing system comprises a receiver that receives database query inputs with a top request, and a sort logic that sorts the inputs using temporary files to store intermediate sort data and applies top qualifications to sorted output. An optimizing logic that modifies operation of the sort logic and reduces the number of records in the inputs that are copied into temporary files.

### BRIEF DESCRIPTION OF THE DRAWINGS

Embodiments of the invention relating to both structure and method of operation may best be understood by referring to the following description and accompanying drawings:

FIG. 1 is a schematic block diagram illustrating an embodiment of a query processing system that performs multiple optimizations of a merge sort for “top” operations;

FIG. 2 is a schematic block diagram illustrating another embodiment of a query processing system for performing multiple optimizations of a merge sort for “top” operations;

FIG. 3 is a schematic block diagram showing a further embodiment of a computer-implemented system that performs multiple optimizations of a merge sort for “top” operations;

FIG. 4 is a schematic block diagram depicting an embodiment of a computer-implemented system in the form of an article of manufacture that can also perform multiple optimizations of a merge sort for “top” operations;

FIGS. 5A and 5B (separated into 5B(1-2)) are flow charts illustrate one or more embodiments or aspects of a computer-executed method for performing optimizations of a merge sort for “top” operations;

FIG. 6 is a data diagram showing operation of the first optimization in which the run size is limited;

FIG. 7 is a data diagram showing operation of an implementation of the second optimization which functions on the basis of lowest cutoff;

FIG. 8 is a data diagram depicting an example operation using the third and fourth optimizations of balanced deferment;

FIG. 9 is a data diagram showing an example operation using the fifth optimization of input filtering;

FIG. 10 is a data diagram illustrating an example operation using the sixth optimization of recycling runs; and

FIG. 11 is a data diagrams showing an example operation using the seventh optimization of early merge or analysis.

### DETAILED DESCRIPTION

The commonly presumed implementation of “top” operations using an in-memory priority queue is simple and fast, but cannot be relied upon in many situations. The common characteristic of these situations is that the final output size is (or might be) larger than the available in-memory workspace. If unable to guarantee that the output will fit in the available memory, a robust “top” algorithm such as an external merge sort is used. In many cases, the optimizations disclosed herein and associated improvements enable an external merge sort to perform as well as a special-purpose “top” algorithm, which has multiple drawbacks and limitations, and enables a single algorithm for “top” queries which reduces effort for code maintenance, testing, and the like, but also prevents erroneous choices among alternative algorithms during query optimization.

“Top K” queries reduce a query result to the most interesting or the most urgent items. In many cases, such as when the result size is unbounded due to duplicate key values, a “top” operation cannot be implemented using the commonly presumed algorithm based on an in-memory priority queue. The usual default alternative is a full sort. In several example embodiments or implementations, external merge sort can be enhanced with multiple novel optimizations specific to “top” operations which are simple to implement yet greatly reduce the data volume written to runs on temporary storage. Analysis of the optimizations shows substantial performance improvement.

In various embodiments of a query processing system, one or more of multiple optimizations of external merge sort can be used for “top” operations. The illustrative techniques are very effective, yet simple to implement within an existing implementation of external merge sort. The techniques can be combined and can complement one another. The performance advantages of the disclosed techniques are expected to reach multiple orders of magnitude. Thus, performance of external merge sort with the optimizations may be much closer or even equal to the in-memory algorithm in comparison to a “top” query using a traditional external merge sort.

The proposed optimizations of external merge sort are very simple to implement but nonetheless enable a general, robust, efficient, and scalable implementation for all variations of “top” queries. The resulting integration of “top” and external merge sort always performs better than the prior robust algorithm, a full sort followed by the “top” operation. In many cases, the performance advantage amounts to an order of magnitude or more.

An optimized sort algorithm using the techniques disclosed herein can process “top” operations very efficiently even with input or output larger than the available memory. Thus, with an appropriate implementation, “top” queries searching for the most urgent or the most important items can be applied with confidence to the largest databases and the largest intermediate query results. Advantages of the optimized techniques can be measured in the number of records written to intermediate runs files. Records never written obviously can never be read or used in other data processing.

Moreover, sorting as the basis for “top” operations permits easy and efficient integration of “group by” clauses, such as the best athletes grouped by age and gender or the most promising potential customers in each region. A “top” operation applied to disjoint subsets of the input uses a nested sub-query in SQL syntax that cannot be resolved (“un-nested” or “flattened”) during query optimization. Query execution plans with such nested iteration are liable to be rather inefficient. A “top” implementation that supports groups, such as external merge sort, permits un-nesting such queries during the optimization process, leading to better performance, better scalability, and more confident usage of “top” queries.

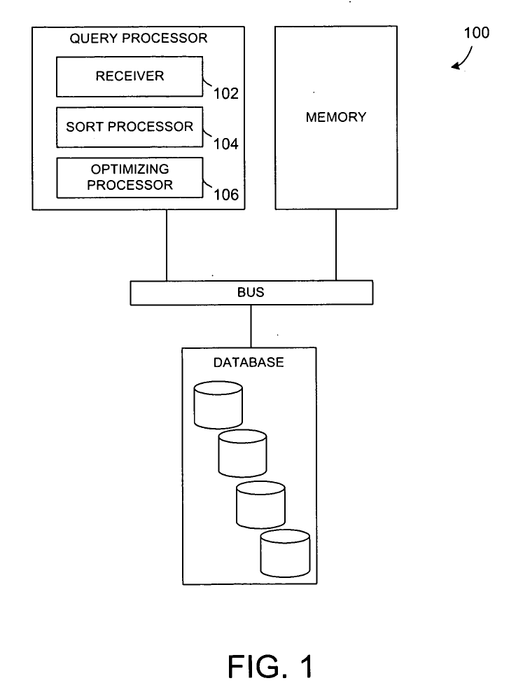

Referring to FIG. 1, a schematic block diagram illustrates an embodiment of a query processing system 100 that performs multiple optimizations of a merge sort for “top” operations. The illustrative query processing system 100 comprises a receiver 102 that receives database query inputs with a top request or top syntax, and a sort logic 104 that sorts the inputs using temporary files to store intermediate sort data and applies top qualifications to sorted output. An optimizing logic 106 that modifies operation of the sort logic 104 and reduces the number of records in the inputs that are copied into temporary files.

In an example implementation of the query processing system 100, the sort logic 104 can sort the inputs using an external merge sort.

The optimizing logic 106 can comprise a plurality of optimizations forming a coherent set of optimizations that apply in multiple different, complementary conditions and function according to multiple different, complementary theoretical bases. For example, a run size limit optimization can exploit large memory, a lowest cutoff optimization exploits presorted inputs, and a balance deferment optimization mitigates a reverse sorted input. An input filter optimization is self-sharpening for large inputs. A recycling runs optimization filters a fast-start for small input. An early analysis optimization mitigates small memory.

The various disclosed optimizations of the optimization processor 106 may perhaps be intuitive once recognized and understood, and are highly simple to implement. In fact, simplicity while attaining substantial performance benefits is part of the value of the optimizations.

The first optimization operates by limiting the run size, which is similar to operation of early duplicate removal and applies to runs in sort operations for “top” operations. The “top” predicate can be applied to each run as written, such as after the in-memory sort. Similar to early duplicate removal, the “cutoff” optimization improves sort performance which limits the size of intermediate files to the sort of the output, and is effective if the data reduction factor is higher than the fan-in of the final merge step.

For example, a sort to find the “top 10,000” potential customers should never write runs larger than 10,000 records (assuming no duplicate values in the sort key).

The expected value of the simple first optimization depends on the relationship of final output size and average run size. Initial runs can be created using Quicksort or replacement selection. (Quicksort is a well-know sort algorithm developed by C. A. R. Hoare.) If runs are cut short based on a “top” specification, fewer runs, each representing more input, increase the effectiveness of the cutoff optimizations.

In a second optimization, the optimizing logic 106 can perform optimization of cutoff runs in which non-increasing cutoff values are set. After a run on temporary storage is cut off at a specific value because the run at the value satisfies the “top” clause, all future runs should be cut off no later than the value. In other words, the cutoff value can be preserved from one run to the next and never increases.

For example, assuming a user specification of “top 3 with ties” and a first run on disk with values 11, 23, 30, 30, 30, then all subsequent runs should not contain values higher than 30 even the result is that the runs contain fewer than 3 rows. Some future runs on temporary storage may even contain no records at all and thus may be omitted entirely.

The expected value of the second optimization is very moderate for truly random input, perhaps even negligible. If a positive correlation exists between the original input sequence and the required output sequence, however, the effect is such that many future output runs may be empty.

In a third optimization, the sort logic 104 performs run generation using replacement selection and the optimizing logic 106 defers replacement selection. Replacement selection is a known technique which relies on deferring keys from the current output run to the next output run. The third optimization exploits replacement selection by cutting the current run short after deferment of a key, thereby terminating runs at a size smaller than the final output.

The third optimization is thus implemented in conjunction with deferment in replacement selection. If run generation employs replacement selection, each key too small for inclusion in the current run permits cutting the current run shorter than the final output. In other words, the current run need not be filled to the size of the final output if certain that the next run will include records with keys earlier in the final output. If the condition occurs repeatedly, the run size can be cut repeatedly.

For example, assuming the final output size is 100 records, the sort operation is currently creating the second run on temporary storage, and the key value most recently written to that run is 20, the next input record satisfying the input filter is compared with the key value. Assuming the input record's key is 15, and thus smaller than 20, the input record cannot be included in the second run and must be deferred to the third run. However, the second run can now be cut short at 99 records. When the runs are merged, the key value 15 from the third run will ensure that no more than 99 records are needed from the second run. If a second record is deferred, the current run can be cut off after 98 records, and so on.

The expected value of the third optimization can be substantial. In a sort operation without any modifications for “top” semantics, an incoming record is deferred with probability 0.5. Moreover, if a negative correlation exists between the original input sequence and the required output sequence, even more input records are deferred to the next run on temporary storage and, based on the technique, contribute to shortening the current run.

In a fourth optimization, the optimizing logic 106 implements a self-sharpening input filter. After a run on temporary storage has been cut off at a specific value, all future input values larger than the value can be discarded immediately. The discarded records never require memory in the sort operation's workspace and never participate in the comparisons for run generation. The effectiveness of the fourth technique increases as run generation progresses. The cutoff value of the first run limits the input values considered for the second run, meaning that more input records are consumed while producing the second run than had been consumed for the first run. The user's “top K” request is satisfied by a lower cutoff value in the second run. The third run benefits from the lower filter cutoff and produces an even lower cutoff for the fourth run, and so on. The number of input records consumed for each run grows exponentially, reducing the number of runs compared to a standard external merge sort.

An additional beneficial effect of the fourth optimization is reduction in the number of runs on temporary storage, thus a reduction in merge effort or in memory used during the merge operation. If graceful degradation is employed, reducing the number of runs on temporary storage reduces the number of input buffers during the merge step and thus permits retaining more records from run generation to the merge, further reducing the number of records written to runs.

For example, assuming a user specifies “top 3 with ties,” the possible key values in the input are 1 to 100, the keys are distributed uniformly in the input, and memory available for run generation can hold 10 records, then the third-lowest key among the first 10 input records may be 30 and the first run might contain the keys 11, 23, 30, 30. For the second run, only records with key values up to 30 fill the 10 available slots in memory. To find records for the second run, about 33 input records are consumed. The output values in the second run may be 6, 6, and 12. For the third run, only records with key values up to 12 fill the available slots in memory, chosen from about 80 input records. The output values now may be 2, 4, 4, 4. For the fourth run, memory is filled with 10 records with key values no larger than 4, chosen from about 250 input records.

The expected value of the fourth optimization can be, as already suggested in the example hereinabove, quite dramatic. With run sizes limited to the smaller of (twice) the memory size and the final output size, fewer runs generated due to more input consumed per run imply less overall input/output (I/O). The multiplier in the exponential growth depends on the quotient of (twice) memory size and the final output size.

In a fifth optimization, the optimizing logic 106 performs optimization that recycles initial runs wherein records of a selected run are not written to temporary storage and are re-inserted into a priority queue. Thus the fifth optimization recycles initial runs. Rather than writing records to the first run on temporary storage, the records can be re-inserted into the priority queue and thus deferred to the second run. In other words, records are “recycled” into run generation and all actual I/O for the first run is avoided, yet the filter on the input is sharpened nonetheless. The cost for achieving the beneficial effect is that some records and associated keys are processed multiple times by the priority queue used for run generation, resulting in additional key comparisons. If desired, the technique can be applied multiple times.

For example, assuming a “top 3” operation with a memory allocation equal to 10 records, after memory is filled with the first 10 input records, a cutoff value can be established after cycling the first 3 records back into the priority queue. The other 7 records are discarded by the cutoff logic. The newly established filter accepts only about 30% of input records (assuming uniform distributions), and filling 7 slots consumes about 23 input records (7÷30%). A second recycling establishes a lower cutoff using the “top 3” values among the first 33 input records (10 initial input records+23 input records to fill 7 slots). The next, sharper filter accepts only about 9% of subsequent input records.

The expected value of the fifth optimization is proportional to the ratio of final output size and memory allocation, and is exponential with the number of initial runs that are recycled rather than written to runs on temporary storage. If the “top” operation's final output is much smaller than the available memory allocation, recycling two or three initial runs may enable an in-memory sort operation.

In a sixth optimization, the sort logic 104 performs a first merge operation of the external merge sort when a selected number of input runs are complete. The sixth optimization invokes an early merger or analysis. If the final output of the “top K” operation is larger than the available memory and the initial runs on temporary storage, the first through fifth optimizations disclosed hereinabove fail to initialize and to reduce the number or size of initial runs. To avoid the cost of a traditional external merge sort of the entire input, the first merge operation can be performed as soon as a few runs exist. A variation of the sixth technique avoids the actual merge effort and merely analyzes the runs on temporary storage, an analysis that obtains a lower cutoff value and thus a cutoff filter for the input.

For example, if the size of memory and of initial runs on temporary storage is 10,000 records yet the “top” specification calls for 50,000 final output records, an analysis of the first 10 runs (about 100,000 records) establishes a filter that immediately removes 50% of all subsequent input records. A first analysis after 25 runs (about 250,000 records) permits immediate removal of 80% of all subsequent input records.

The expected value of the sixth optimization depends on multiple factors, including the timing of the analysis and possible repeated applications.

The optimization logic 106 can implement any or all of the six specific, simple optimizations for external merge sort used for “top” queries, possibly in addition to other suitable optimizations. Among the optimizations, the first optimization exploits memory and runs larger than the final output size, the only case in which the traditional “top” algorithm with an in-memory priority queue works. The sixth optimization mitigates memory much smaller than the final output. The second optimization exploits pre-sorted inputs. The third optimization mitigates reverse sorted inputs. The fourth optimization improves scalability for large inputs. The fifth optimization quick-starts the filter cutoff for small inputs. Although the new techniques are most effective in different circumstances, the optimizations can be readily combined into a single algorithm that adapts to the input. An optimizing logic 106 including all six optimizations can be implemented with only a small increase in logic over a traditional merge sort.

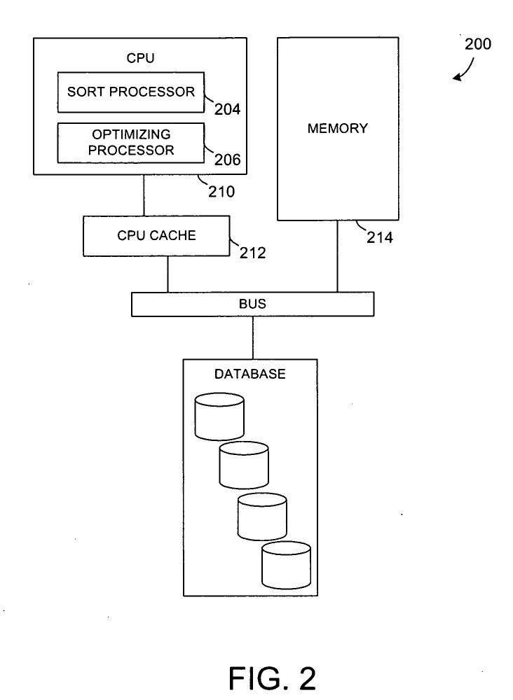

Referring to FIG. 2, a schematic block diagram illustrates another embodiment of a query processing system 200 that performs multiple optimizations of a merge sort for “top” operations. The query processing system 200 comprises a central processing unit (CPU) 210 comprising the sort logic 204 that sorts the inputs using an external merge sort and the optimizing logic 206 which modifies operation of the sort logic 204. A first level storage 212, for example a CPU cache, coupled to the CPU 210 can store data from internal run generation of the external merge sort. A second level storage 214, for example memory, coupled to the first level storage 212 and stores external runs of the external merge sort. The optimizing logic 206 can optimize the external merge sort so that inputs larger than the first level storage size are enabled.

In the illustrative query processing system 200 embodiment, external merge sort is adapted such that internal run generation is limited to the CPU cache and external runs are in memory. Because cache sizes are limited, the novel optimizations and algorithm improvements enable efficient “top” queries with inputs and outputs larger than the CPU cache, in contrast to larger than memory.

The illustrative example system 200 embodiment describes particular storage devices for the first level 212 and second level 214 storage. Any suitable storage devices can be used including cache, various memory types, disks, flash drives, and the like. Generally, the first level storage 212 enables access to data at a substantially higher speed and lower burden than the second level storage 214.

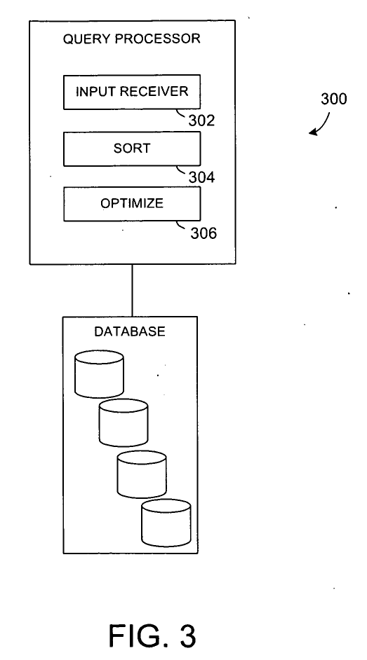

Referring to FIG. 3, a schematic block diagram illustrates an embodiment of a computer-implemented system 300 that performs multiple optimizations of a merge sort for “top” operations. The computer-implemented system 300 comprises means 302 for receiving database query inputs with a top request or top syntax, and means 304 for sorting the inputs using temporary files to store intermediate sort data and applies top qualifications to sorted output. Means 306 for optimizing sorting modifies operation of the sorting means 304 so that the number of records in the inputs that are copied into temporary files is reduced.

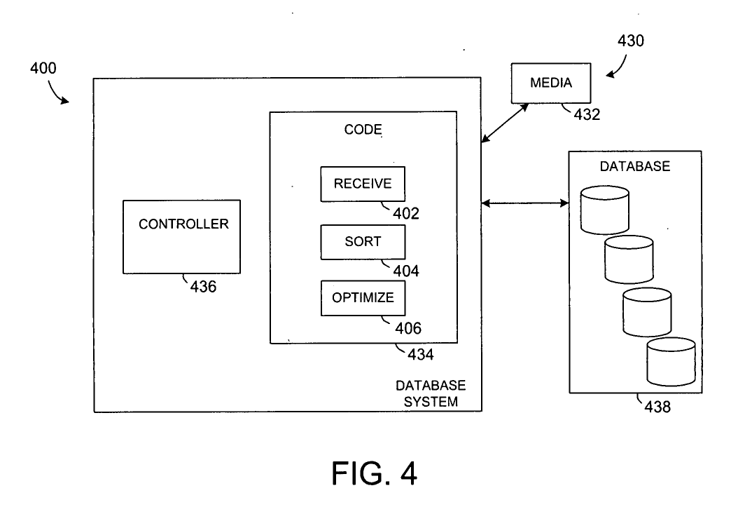

Referring to FIG. 4, a schematic block diagram illustrates an embodiment of a computer-implemented system 400 in the form of an article of manufacture 430 that can also perform multiple optimizations of a merge sort for “top” operations. The article of manufacture 430 comprises a controller-usable medium 432 having a computer readable program code 434 embodied in a controller 436 for performing query processing in a relational database 438. The computer readable program code 434 comprises code 402 causing the controller 436 to receive database query inputs with a top request such as a request with a top syntax, and code 404 causing the controller 436 to sort the inputs using temporary files to store intermediate sort data and applies top qualifications to sorted output. The computer readable program code 434 further comprises code 406 causing the controller 436 to modify operations to optimize sorting so that the number of records in the inputs that are copied into temporary files is reduced.

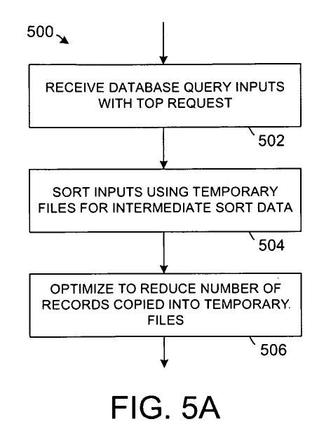

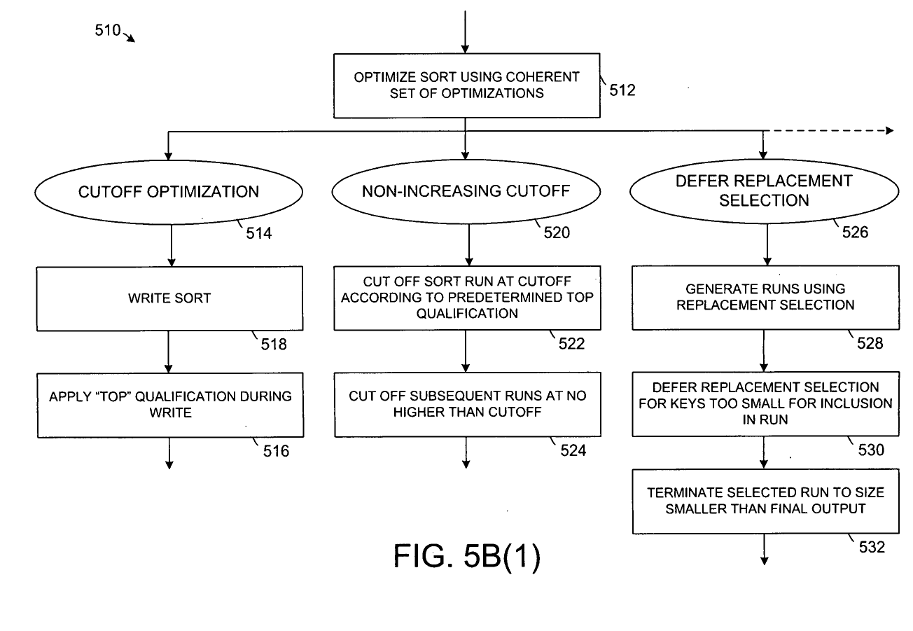

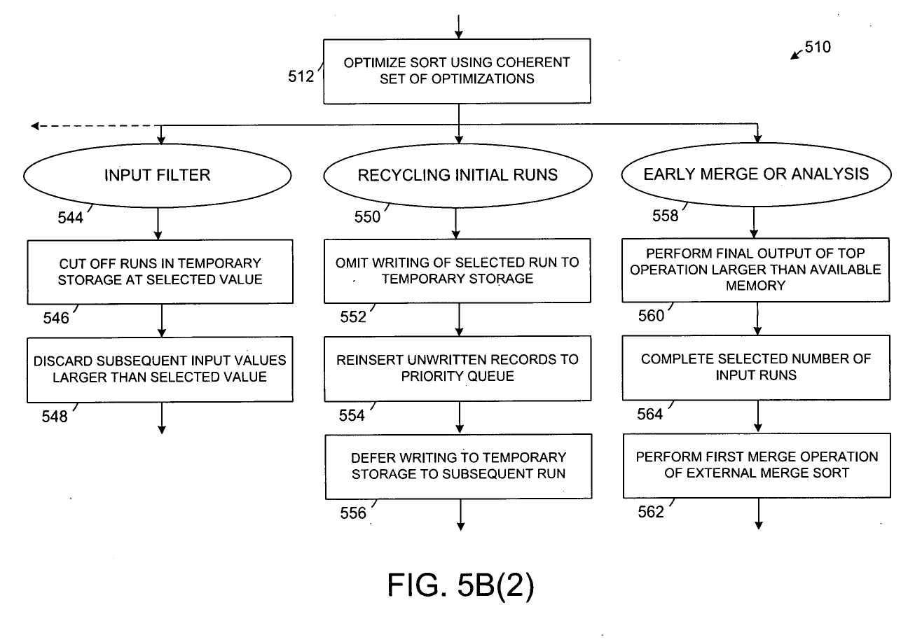

Referring to FIGS. 5A and 5B, flow charts illustrate one or more embodiments or aspects of a computer-executed method for performing optimizations of a merge sort for “top” operations. FIG. 5A depicts an embodiment of a computer-executed method 500 for query processing in a relational database comprising receiving 502 database query inputs with a top syntax, sorting 504 the inputs using temporary files to store intermediate sort data, and applying 506 top qualifications to sorted output. Optimization techniques can be used to reduce 508 the number of records in the inputs copied into temporary files.

In various embodiments, the inputs can be sorted using an external merge sort. Thus, the optimizations can be implemented as simple improvements for a traditional external merge sort that enable performance advantages for “top” queries implemented by sorting the input.

Referring to FIG. 5B, an embodiment of a computer-executed method 510 for query processing in a relational database can further comprise optimizing 512 the sorting using a plurality of optimizations forming a single, coherent set of optimizations that apply in multiple different, complementary conditions and function according to multiple different, complementary theoretical bases. The optimizations can include a first, cutoff optimization 514 wherein a predetermined top qualification is applied 516 to each sort run as the run is written 518.

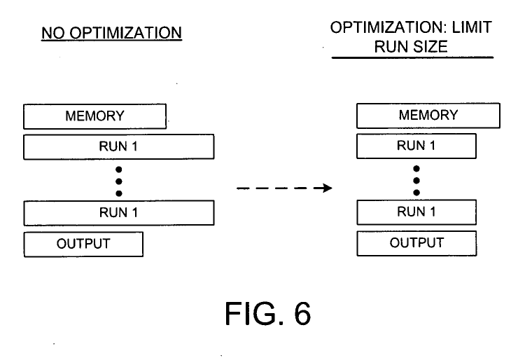

FIG. 6 illustrates operation of the first optimization in which the run size is limited. The technique produces runs no larger than the final output. The optimization applies the top-K specification to each run, independent of grouping, for example “Top K . . . group by . . . ” and the like. The effect of the optimization is that no run is larger than the final output. The optimization is very effective if runs of a traditional external merge sort are larger than the final output, and benefits from replacement selection.

A second optimization 520 is defined by non-increasing cutoff values so that for a sort run 522 on temporary storage that is cut off at a cutoff value determined by operation of a predetermined top qualification, subsequent runs are cut off 524 at a value no higher than the cutoff value.

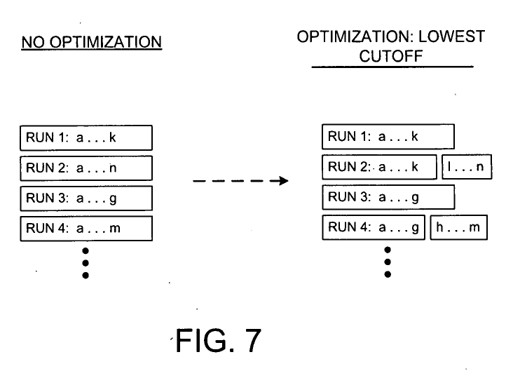

FIG. 7 shows operation of an implementation of the second optimization which functions on the basis of lowest cutoff, imposing prior size limits are per run. Lowest cutoff can be implemented for duplicate elimination grouping and top K. Lowest cutoff optimization improves performance by retaining the lowest cutoff key from run to run, never resetting or increasing the cutoff key. The effect of the lowest cutoff optimization is small for random input data, but substantial for pre-sorted data.

A third optimization 526 can be implemented when sorting employs replacement selection for run generation 528. For optimization that defers replacement selection where replacement selection is deferred 530 for keys too small for inclusion in a selected run, the selected run is terminated 532 to a size smaller than final output.

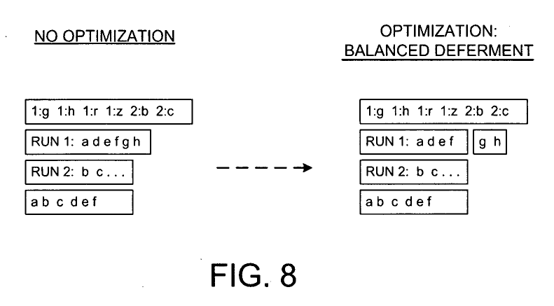

FIG. 8 depicts an example operation using the third optimization of balanced deferment. The technique uses traditional replacement selection. A priority queue in memory contains keys for two runs. If the input key is smaller than written key, the input key is deferred. The optimization leads to improvement since deferment reduces run size. The effect of the optimization is that runs are shorter than top case specification. Balanced deferment is effective for small memory versus final output size, and effective for reverse sorted input.

A fourth optimization 544 can be implemented as a self-sharpening input filter such that for a run on temporary storage that is cut off at a selected value 546, all subsequent input values larger than the selected value are immediately discarded 548.

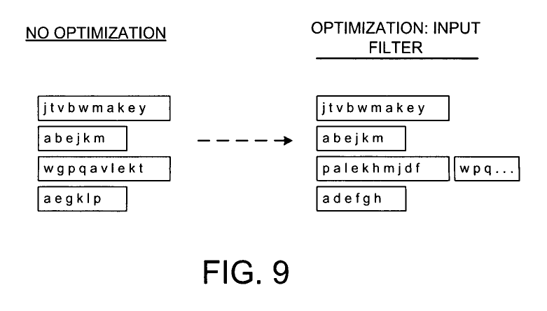

FIG. 9 shows an example operation using the fourth optimization of input filtering. The input filter optimization enables improvement by exploiting output cutoff as an input filter. For example, assuming use of Quicksort and unique keys, Top-40 operation, memory size 50, input keys 1-10,000, the cutoff values can be about 8000, 6400, 5120, 4096, and so on. The effect of input filtering is to grow input consumption per run with fewer runs. The input filter is a self sharpening filter which is effective after a few runs and is increasingly effective while consuming a large input.

A fifth optimization 550 can be performed by recycling initial runs so that records of a selected run are not written 552 to temporary storage and are re-inserted 554 into a priority queue. Writing to the temporary storage is deferred 556 to a subsequent run.

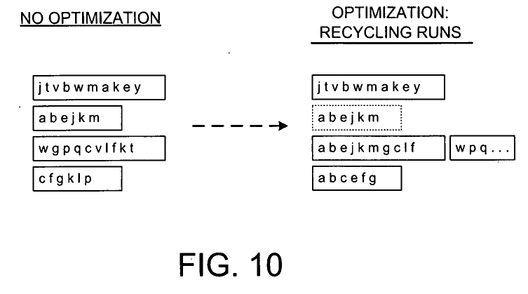

FIG. 10 shows an example operation using the fifth optimization of recycling runs. In the recycling runs optimization, the input filter fails to reduce first run and run generation always writes most of the early runs. Relative performance with run recycling is worst for smallest inputs. The recycling runs optimization improves performance by recycling the first run, then setting cutoff and filter, while ejecting large keys. The process is applied repeatedly to exploit filter sharpening. The effect of recycling runs is that some overhead is incurred versus sharp filter even for the first run. Zero records are written in the best case.

A sixth optimization 558 is operative for a final output of a top operation larger than available memory 560 so that initial runs on temporary storage include a first merge operation 562 of the external merge sort when a selected number of input runs are complete 564.

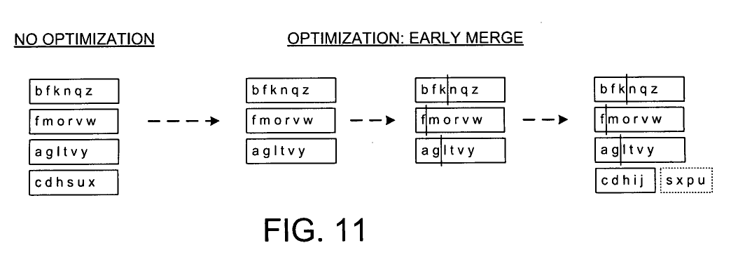

FIG. 11 shows an example operation using the sixth optimization of early merge or analysis. In early merge or analysis, the final output may be much larger than memory and the cutoff and filter optimizations can fail to initialize. The early merge or analysis optimization enables improvement since the cutoff is found by combining the first few runs. The technique is repeatable, if desired. The effect of early merge or analysis optimization depends on timing and repetition.

In some cases, the standard algorithm for “top” operations (employing an in-memory priority queue) is insufficient. For many reasons the main assumption of the traditional in-memory algorithm may not be satisfied. Any one of the reasons suffices to render the traditional in-memory algorithm unsafe or entirely unusable.

Concurrent or interleaved algorithms can employ two priority queues, one in ascending order for traditional run generation and one in descending order for filtering incoming input records as used in the traditional “top” algorithm strictly limited to in-memory execution. The novel optimization techniques disclosed herein minimize the modifications of external merge sort and can thus be implemented without the complexity of concurrent or interleaved algorithms.

The novel optimization techniques disclosed herein are run-time techniques rather than compile-time techniques. Nonetheless, prior work on query optimization has assumed that the only alternative to an in-memory priority queue is sorting the entire input with subsequent application of the “top” clause, assumptions that may be reviewed in view of the techniques disclosed herein. For example, the disclosed techniques enable a “top” algorithm that is as robust as sorting the entire input and has performance often closer to an in-memory priority queue than to a full sort operation.

The disclosed optimizations can be applied in a variety of implementations, for example with a “top” algorithm using merge sort applied to CPU caches and main memory, and in parallel execution of “top” queries, not only those with “group by” specification but also those without. The disclosed optimization techniques can improve the performance of parallel sort operations.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A query processing system comprising:
a receiver that receives database query inputs with a top request;
a sort logic that sorts the inputs using temporary files to store intermediate sort data and applies top qualifications to sorted output; and
an optimizing logic that modifies operation of the sort logic and reduces number of records in the inputs copied into temporary files.

2. The system according to claim 1 further comprising:
the sort logic that sorts the inputs using an external merge sort.

3. The system according to claim 1 further comprising:
the optimizing logic comprising a plurality of optimizations forming a single, coherent set of optimizations that apply in multiple different, complementary conditions and function according to multiple different, complementary theoretical bases.

4. The system according to claim 1 further comprising:
a central processing unit (CPU) comprising the sort logic that sorts the inputs using an external merge sort and the optimizing logic;
a first level storage coupled to the CPU that stores data from internal run generation of the external merge sort;
a second level storage coupled to the first level storage that stores external runs of the external merge sort; and
the optimizing logic optimizing the external merge sort wherein inputs larger than the first level storage size are enabled.

5. The system according to claim 1 further comprising:
the optimizing logic comprising a cutoff optimizer wherein a predetermined top qualification is applied to each sort run as the run is written.

6. The system according to claim 1 further comprising:
the optimizing logic comprising an optimizer defined by non-increasing cutoff values wherein for a sort run on temporary storage that is cut off at a cutoff value determined by operation of a predetermined top qualification, subsequent runs are cut off at a value no higher than the cutoff value.

7. The system according to claim 1 further comprising:
the sort logic comprising run generation using replacement selection; and
the optimizing logic comprising an optimizer that defers replacement selection wherein:
replacement selection is deferred for keys too small for inclusion in a selected run wherein the selected run is terminated to a size smaller than final output; or
a selected run is terminated to a size smaller than final output if certain that a run subsequent to the selected run will include records with keys earlier in the final output.

8. The system according to claim 1 further comprising:
the optimizing logic comprising a self-sharpening input filter wherein for a run on temporary storage that is cut off at a given value, all subsequent input values larger than the given value are immediately discarded.

9. The system according to claim 1 further comprising:
the optimizing logic comprising an optimizer that recycles initial runs wherein records of a selected run are not written to temporary storage and are re-inserted into a priority queue and writing to the temporary storage is deferred to a subsequent run.

10. The system according to claim 1 further comprising:
the sort logic that sorts the inputs using an external merge sort; and
the optimizing logic operative for a final output of a top operation larger than available memory and initial runs on temporary storage performs a first merge operation of the external merge sort when a selected number of input runs are complete.

11. A computer-implemented system comprising:
means for receiving database query inputs with a top request;
means for sorting the inputs using temporary files to store intermediate sort data and applies top qualifications to sorted output; and
means modifying operation of the sorting means for optimizing sorting wherein number of records in the inputs that is copied into temporary files are reduced.

12. The system according to claim 11 further comprising:
an article of manufacture comprising:
a controller-usable medium having a computer readable program code embodied in a controller for performing query processing in a relational database, the computer readable program code further comprising:
code causing the controller to receive database query inputs with a top request;
code causing the controller to sort the inputs using temporary files to store intermediate sort data and applies top qualifications to sorted output; and
code causing the controller to modify operation of the sorting to optimize sorting wherein number of records in the inputs that are copied into temporary files are reduced.

13. A method for processing a query comprising:
receiving database query inputs with a top request;
sorts the inputs using temporary files to store intermediate sort data;
applying top qualifications to sorted output; and
reducing number of records in the inputs that is copied into temporary files.

14. The method according to claim 13 further comprising:
optimizing the sorting using a plurality of optimizations forming a single, coherent set of optimizations that apply in multiple different, complementary conditions and function according to multiple different, complementary theoretical bases, the optimizations selected from a group consisting of:
a cutoff optimization wherein a predetermined top qualification is applied to each sort run as the run is written;
an optimization defined by non-increasing cutoff values wherein for a sort run on temporary storage that is cut off at a cutoff value determined by operation of a predetermined top qualification, subsequent runs are cut off at a value no higher than the cutoff value;
sorting comprising run generation using replacement selection and optimization that defers replacement selection wherein replacement selection is deferred for keys too small for inclusion in a selected run wherein the selected run is terminated to a size smaller than final output;
sorting comprising run generation using replacement selection and optimization that defers replacement selection wherein a selected run is terminated to a size smaller than final output if certain that a run subsequent to the selected run will include records with keys earlier in the final output;
optimizing comprising a self-sharpening input filter wherein for a run on temporary storage that is cut off at a selected value, all subsequent input values larger than the selected value are immediately discarded; and
optimizing comprising recycling initial runs wherein records of a selected run are not written to temporary storage and are re-inserted into a priority queue and writing to the temporary storage is deferred to a subsequent run; and
optimizing for a final output of a top operation larger than available memory wherein initial runs on temporary storage comprise a first merge operation of the external merge sort when a selected number of input runs are complete.

15. The method according to claim 13 further comprising:
sorting the inputs using an external merge sort.
